(19) United States
(12) Patent Application Publication
(10) Pub. No.: US 2010/0315996 A1
(43) Pub. Date: Dec. 16, 2010

(54) HOST APPARATUS, TRANSMISSION METHOD AND TANGIBLE MACHINE-READABLE MEDIUM THEREOF

(75) Inventors: Yung-Chih LIU, Taipei (TW); Yu-Kai HUANG, Taichung City (TW); Ai-Chun PANG, Yonghe City (TW); Kuan-Chang CHEN, Sanchong City (TW)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(73) Assignee: INSTITUTE FOR INFORMATION INDUSTRY, Taipei (TW)

(21) Appl. No.: 12/543,134

(22) Filed: Aug. 18, 2009

(30) Foreign Application Priority Data
Jun. 11, 2009 (TW) 098119519

(51) Int. Cl. H04W 88/08

(52) U.S. Cl. 370/328

(57) ABSTRACT

A host apparatus, a transmission method and a tangible machine-readable medium storing a program of the transmission method for use in the host apparatus are provided. The host apparatus is for use in a wireless network which comprises a plurality of access points and a mobile node. The access points are wirelessly connected to the host apparatus. The host apparatus stores a statistics table relating to the mobile node. The host apparatus may be aware of the possible moving paths about the mobile node and proceed the data transmission with the mobile node via the access points in the possible moving paths, so as to save the resource of the wireless network.

This application claims the benefit of priority based on Taiwan Patent Application No. 098119519 filed on Jun. 11, 2009.

### CROSS-REFERENCES TO RELATED APPLICATIONS

Not applicable.

### BACKGROUND OF THE INVENTION

1. Field of the Invention

The present invention relates to a host apparatus, a transmission method and a tangible machine-readable medium storing a program of the transmission method for use in the host apparatus, and more particularly, relates to a host apparatus, a transmission method and a tangible machine-readable medium storing a program of the transmission method for use in the host apparatus capable of predicting a moving path of a mobile node.

2. Descriptions of the Related Art

With continuous advancement in science and technology, people are imposing ever higher requirements on communications. Nowadays, more and more importance is being attached to convenience of communications in addition to requirements on quality of communications. Wireless communications are advantageous in that they provide higher mobility by obviating the need of physical communication network wiring. Therefore, wireless-communication-enabled products such as mobile phones, notebook computers and the like are more and more popular in recent years and have become the mainstream products in the consumer electronics market.

Typically, a wireless-communication-enabled product is carried by a user to move about, so it may be considered as a mobile node. Due to the mobility of mobile node, it is impossible to establish a fixed burst routing path in the wireless network. To maintain a certain level of wireless communication quality, access points are typically deployed widely by communication service providers to transmit signals (which may be viewed as burst transmission) to mobile nodes through broadcasting. This can avoid mobile nodes from failing to continuously receive the service provided by the service provider when moving out of signal coverage of an access point.

However, this transmission method that transmits bursts through broadcasting has the following disadvantages:
(1) the broadcast necessitates transmission of signals to each of the access points, resulting in generation of a large amount of bursts which may occupy massive wireless network resources;
(2) the broadcast consumes a large amount of register space resources of the access points.

In summary, efforts still have to be made in the art to provide mobile nodes in the wireless network with good wireless communication quality without consuming massive wireless network resources and register space resources of access points.

### SUMMARY OF THE INVENTION

One objective of the present invention is to provide a solution for wireless communication. According to this solution, access points in possible moving paths of a mobile node are known from a statistics table, and then signal transmissions (i.e., burst transmissions) are carried out through multicast via the access points in the possible moving paths. This solution may not only provide mobile nodes in the wireless network with good wireless communication quality, but also reduce unnecessary consumption of wireless network resources and usage of register space resources of access points.

To this end, the present invention provides a host apparatus for use in a wireless network comprising a first access point, a second access point and a mobile node. The host apparatus is wirelessly connected to the first access point and the second access point. The first access point has a first signal coverage and transmits positioning information relating to the mobile node to the host apparatus, the second access point has a second signal coverage, and the mobile node is within the first signal coverage. The host apparatus comprises a storage module, a transceiver, a determination module and an update module.

The storage module is configured to store a statistics table relating to the mobile node. The transceiver is configured to receive the positioning information. The update module is configured to update the statistics table of the storage module according to the received positioning information. The determination module is configured to confirm that the mobile node is currently within the first signal coverage according to the received positioning information to generate a confirmation result, and determine that the mobile node is moving toward the second signal coverage according to the updated statistics table and the confirmation result, so as to add the second mobile node to a transmission list. The transceiver is further configured to transmit a burst to the second access point in a multicast way according to the transmission list so that the mobile node may receive the burst via the second access point after entering the second signal coverage.

To this end, the present invention further provides a transmission method for use in a host apparatus. The host apparatus is adapted to be used in a wireless network comprising a first access point, a second access point and a mobile node. The host apparatus is wirelessly connected to the first access point and the second access point, and stores a statistics table relating to the mobile node. The first access point has a first signal coverage and transmits positioning information relating to the mobile node to the host apparatus, the second access point has a second signal coverage, and the mobile node is within the first signal coverage.

The transmission method comprises the following steps of: (a) receiving the positioning information; (b) updating the statistics table according to the received positioning information; (c) confirming that the mobile node is within the first signal coverage according to the received positioning information to generate a confirmation result; (d) determining that the mobile node is moving toward the second signal coverage according to the updated statistics table and the confirmation result to add the second access point to a transmission list; and (e) transmitting a burst to the second access point in a multicast way according to the transmission list so that the mobile mode may receive the burst via the second access point after entering the second signal coverage.

To this end, the present invention provides a tangible machine-readable medium storing a program of a transmission method for use in a host apparatus. The host apparatus is adapted to be used in a wireless network and comprises a storage module, a transceiver, an update module and a determination module. The wireless network comprises a first access point, a second access point and a mobile node. The host apparatus is wirelessly connected to the first access point and the second access point. The storage module stores a statistic table relating to the mobile node, the first access point has a first signal coverage and transmits positioning information relating to the mobile node to the host apparatus, the second access point has a second signal coverage, and the mobile node is within the first signal coverage.

The program of the transmission method is loaded into the host apparatus via a computer to execute: a code A enabling the transceiver to receive the positioning information; a code B enabling the update module to update the statistic table according to the received positioning information; a code C enabling the determination module to confirm that the mobile node is currently within the first signal coverage according to the positioning information to generate a confirmation result; a code D enabling the determination module to determine the mobile node is moving toward the second signal coverage according to the updated statistic table and the confirmation result to add the second access point to the transmission list; and a code E enabling the transceiver to transmit a burst to the second access point in a broadcast way according to the transmission list so that the mobile node may receive the burst via the second access point after entering the second signal coverage.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 depicts a wireless network according to a first embodiment of the present invention;

FIG. 2 depicts a host apparatus according to the first embodiment of the present invention;

FIG. 3 depicts a determination module according to the first embodiment of the present invention; and

FIGS. 4A-4B depict a transmission method according to a second embodiment of the present invention.

### DESCRIPTION OF THE PREFERRED EMBODIMENT

In the following description, this invention will be explained with reference to embodiments thereof. However, these embodiments are not intended to limit this invention to any specific environment, applications or particular implementations described in these embodiments. Therefore, description of these embodiments is only for purpose of illustration rather than to limit this invention. It should be appreciated that, in the following embodiments and the attached drawings, elements unrelated to this invention are omitted from depiction; and dimensional relationships among individual elements in the attached drawings are illustrated only for ease of understanding, but not to limit the actual scale.

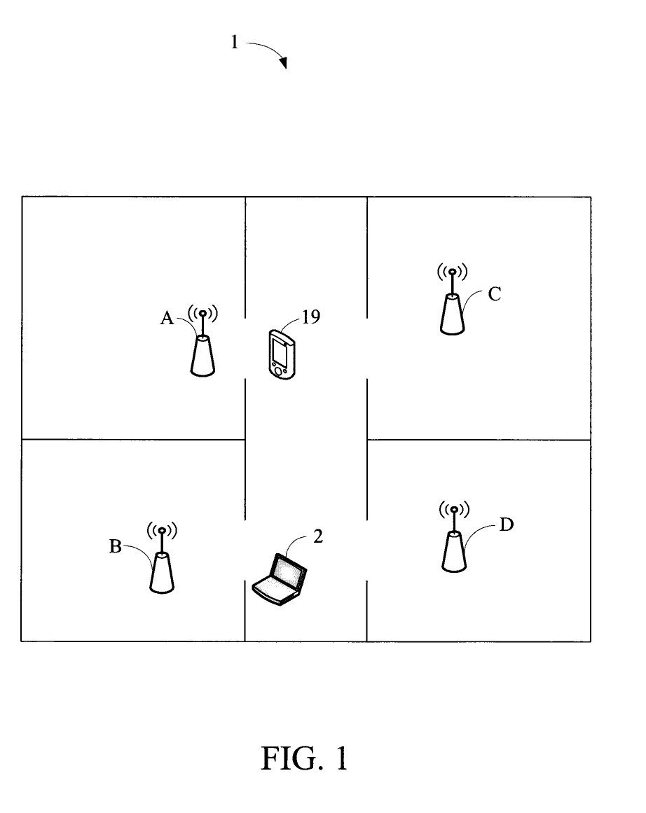

A first embodiment of the present invention is shown in FIG. 1, which is a schematic view of a wireless network 1 deployed inside an office. It should be appreciated that, the wireless network 1 may also be deployed in other spaces, which may be readily understood by those of ordinary skill in the art and thus will not be further described herein. The wireless network 1 comprises a plurality of access points, a mobile node 19 and a host apparatus 2. In the following description, four access points (i.e., access points A, B, C and D) will be described as an example, in which the access point A may be called as a first access point, and the access point B may be called as a second access point. Each of the access points can position the mobile node 19 to generate positioning information. Taking the access point A as an example, it positions the mobile node 19 to generate positioning information 30. In other embodiments, the wireless network may comprise other numbers of access points and mobile nodes instead of being limited thereto.

In the wireless network 1, the host apparatus 2 is wirelessly connected to the access points A, B, C and D, and each of the access points A, B, C and D has a signal coverage. For example, the access point A has a first signal coverage, and the access point B has a second signal coverage. The mobile node 19 is currently positioned within the first signal coverage of the access point A.

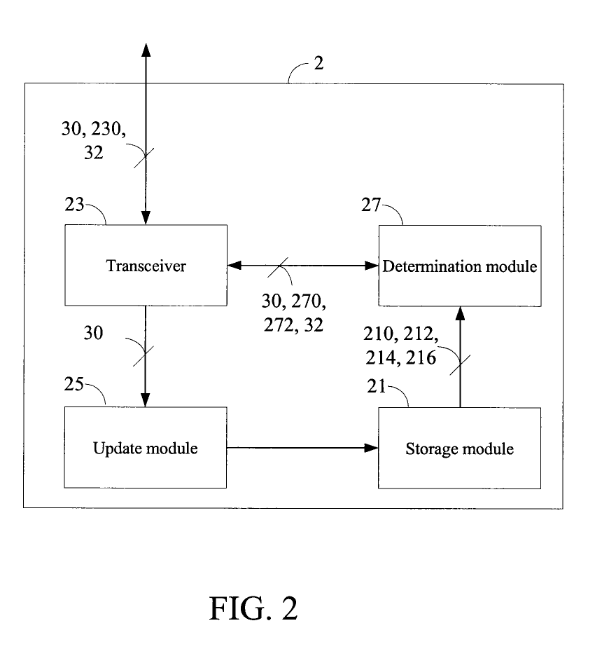

Hereinafter, how the host apparatus 2 determines possible moving paths of the mobile node 19, and transmits a burst to the mobile node 19 via access points in the possible moving paths will be described. Referring to FIG. 2 together, a schematic view of the host apparatus 2 is shown therein. The host apparatus 2 comprises a storage module 21, a transceiver 23, an update module 25 and a determination module 27. The storage module 21 is configured to store a statistics table relating to the mobile node 19, the transceiver 23 is configured to receive the positioning information 30, and the update module 25 is configured to update the statistics table of the storage module 21 according to the received positioning information 30.

The determination module 27 is configured to confirm that the mobile node 19 is currently within the first signal coverage of the access point A according to the received positioning information 30 to generate a confirmation result, and determine that the mobile node 19 is moving toward the second signal coverage according to the updated statistics table 210 and the confirmation result, so as to add the access point B to a transmission list 270. The transceiver 23 is further configured to transmit a burst 230 to the access point B through multicast according to the transmission list 270 so that the mobile node 19 may receive the burst 230 via the access point B after entering the second signal coverage.

In other words, when the mobile node 19 is moving from the first signal coverage toward the second signal coverage, the mobile node 19 may be viewed as moving from the access point A toward the access point B, so the access point B is determined by the determination module 27 to be an access point in a possible moving path of the mobile node 19 and is added to the transmission list 270 so that the transceiver 23 of the host apparatus 2 can transmit data to the mobile node 19 via the access point B.

It should be noted that, although this embodiment is described only by adding the access point B to the transmission list 270, other access points (e.g., the access points C and/or D) may also exist in the possible moving paths of the mobile node 19. In this case, by following the same way as that used to add the access point B to the transmission list 270, the determination module 27 may add the other access points in the possible moving paths of the mobile node 19 to the transmission list 270 so that the transceiver 23 can transmit the burst 230 to the mobile station 19 again through multicast via all the access points in the transmission list 270.

Additionally, to ensure receipt of the burst 230 by the mobile node 19, the determination module 27 is further configured to, after the transceiver 23 has transmitted the burst 230 through multicast according to the transmission list 270, determine whether the transceiver 23 has received a receipt acknowledgement signal 32 transmitted by the mobile node 19 during a specific time period and generate a determination result.

If the determination result indicates that the transceiver 23 has received the receipt acknowledgement signal 32 during the specific time period, the determination module 27 determines that the burst 230 has certainly been received by the mobile node 19 according to the receipt acknowledgement signal 32. Otherwise, if the determination result indicates that the transceiver 23 did not receive the receipt acknowledgement signal 32 during the specific time period, the determination module 27 generates an enable signal 272 for transmission to the transceiver 23 according to the determination result, and the transceiver 23 transmits the burst 32 again through broadcast according to the enable signal 272 so that the mobile node 19 can receive the burst 32 via one of the access point A and the access point B.

Next, how the statistics table stored in the storage module 21 is updated and how the determination module 27 determines that the access point B is in the possible moving paths of the mobile node 19 will be illustrated more clearly. In more detail, the statistics table of the storage module 21 at least contains data amount information, count information corresponding to the mobile node 19, probability information corresponding to the mobile node 19, broadcast overhead information, and communication path information corresponding to the second access point. Firstly, functions of the count information and the probability information will be described. Referring to Table 1, how the count information and the probability information, both corresponding to the mobile node 19, are expressed in the statistics table of the storage module 21 is presented.

TABLE 1

| | A | | B | C | D |
|---|---|---|---|---|---|
| A→ A | Count | 10 | 70 | 11 | 9 |
| | Probability | 10% | 70% | 11% | 9% |
| A→ B | Count | 20 | 30 | 40 | 10 |
| | Probability | 20% | 30% | 40% | 10% |
| A→ C | Count | 50 | 20 | 25 | 5 |
| | Probability | 50% | 20% | 25% | 5% |

. . .

| | | | | | |
|---|---|---|---|---|---|
| D→ C | Count | 33 | 17 | 25 | 25 |
| | Probability | 33% | 17% | 25% | 25% |
| D→ D | Count | 60 | 25 | 5 | 10 |
| | Probability | 60% | 25% | 5% | 10% |

In Table 1, A→B represents that the mobile node 19 is currently at the access point B and its previous position is the access point A. The letters A, B, C and D indicated in the top row represent the next position of the mobile node 19. For example, the field A→B in combination with the field C represent that the mobile node 19 moves from the access point A to the access point B (i.e., the mobile node 19 is currently at the access point B) and the next position thereof will be the access point C. The numeral “40” indicated at an intersection of the field A→B and the field C is the count information relating to the field A→B, which counts the times that the mobile node 19 moves from the access point A to the access point B and then to the access point C. The percentage “40%” indicated at an intersection of the field A→B and the field C is the probability information of the mobile node 19 moving from the access point A to the access point B and then to the access point C, which is calculated from 40/(20+30+40+10). Meanings of other fields in Table 1 can be interpreted similarly and, thus, will not be further described herein.

Additionally, the data amount information is configured to record an upper limit of the amount of data that can be stored in each row of Table 1. In this embodiment, each row of Table 1 can store 100 pieces of data at most. Taking the row corresponding to A→B as an example, the number of data pieces stored therein is a sum of the numerals indicated in the count fields, i.e., 20+30+40+10=100 (which is the upper limit of the amount of data that can be stored in this row). The broadcast overhead information is configured to record the resource overhead necessary for the wireless network 1 to broadcast a burst. The communication path information is configured to record depth of each of communication paths in the wireless network 1.

Referring back to FIG. 2, for purpose of further illustration, this embodiment will assume that the mobile node 19 currently stays at the access point A all along and the next position will be the access point B. Based on this assumption, after the transceiver 23 of the host apparatus 2 has received the positioning information 30, the update module 25 can update the statistics table (i.e., Table 1) relating to the mobile node 19 stored in the storage module 21 according to the positioning information 30. Initially, the update module 25 updates the data amount information and the count information respectively according to the received positioning signal 30, and then updates the probability information according to the updated data amount information and the updated count information to generate the updated statistics table 210. The count information and the probability information in the updated statistics table 210 are as shown in Table 2.

TABLE 2

| | A | | B | C | D |
|---|---|---|---|---|---|
| A→ A | Count | 9.9 | 70.3 | 10.89 | 8.91 |
| | Probability | 9.9% | 70.3% | 10.89% | 8.91% |
| A→ B | Count | 20 | 30 | 40 | 10 |
| | Probability | 20% | 30% | 40% | 10% |
| A→ C | Count | 50 | 20 | 25 | 5 |
| | Probability | 50% | 20% | 25% | 5% |

. . .

| | | | | | |
|---|---|---|---|---|---|
| D→ C | Count | 33 | 17 | 25 | 25 |
| | Probability | 33% | 17% | 25% | 25% |
| D→ D | Count | 60 | 25 | 5 | 10 |
| | Probability | 60% | 25% | 5% | 10% |

In more detail, upon receiving the positioning information 30, the update module 25 is aware that a piece of data relating to the mobile node 19 needs to be stored into Table 1. As can be known from the aforesaid assumption that the mobile node 19 currently stays at the access point A all along and the next position will be the access point B, the previous position of the mobile node 19 is the access point A, the current position thereof is also the access point A and the next position will be the access point B. Hence, the count stored at the intersection of the row A→A and the column B of Table 1 shall be updated from 70 into 71, thereby obtaining the updated count information.

However, the number of data pieces in the row A→A now amounts to 101, which exceeds the upper limit of data pieces that can be stored in each row, so the update module 25 makes an approximate calculation to subtract the previous probability from the count 71 stored at the intersection of the row A→A and the column B, i.e., 71−0.7=70.3, and takes the value 70.3 as the updated probability. Other probabilities are also updated in the same way and thus will not be further described herein. The updated probability information and the updated count information are as shown in FIG. 2. Thus, the updated statistics table is generated by the update module 25.

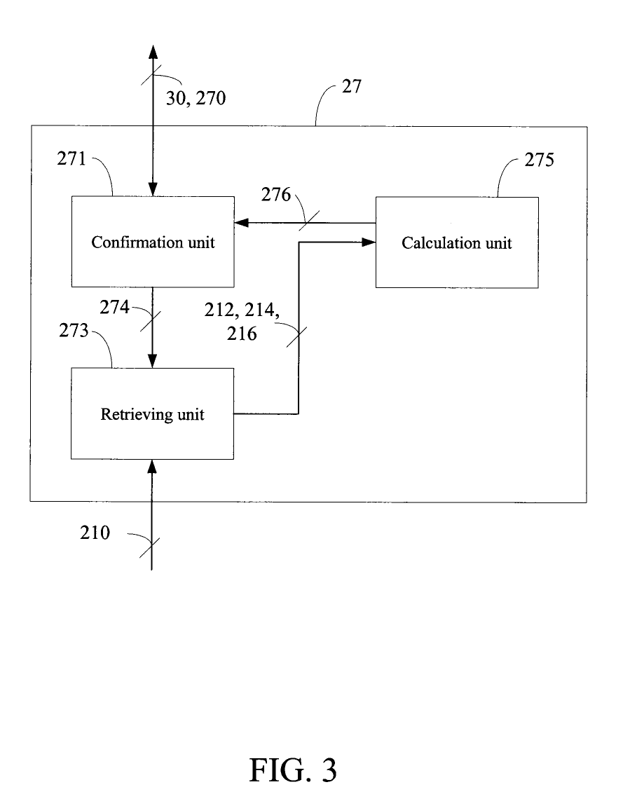

Next, how the determination module 27 chooses the access point B and adds it to the transmission list 270 will be described. Referring to FIG. 3, a schematic view of the determination module 27 is shown therein. The determination module 27 comprises a confirmation unit 271, a retrieving unit 273 and a calculation unit 275. The confirmation unit 271 is configured to confirm that the mobile node 19 is currently within the first signal coverage according to the positioning information 30 to generate a confirmation result 274. The retrieving unit 273 is configured to retrieve the broadcast overhead information 212, the communication path information 214 and the updated probability information 216 from the updated statistics table 210 according to the confirmation result 274, wherein the broadcast overhead information 212 and the communication path information 214 are a constant, respectively, which are known early when the wireless network 1 was deployed and thus will not be further described herein.

The calculation unit 275 is configured to generate a calculation result 276 relating to the access point B according to the updated probability information 216, the broadcast overhead information 212 and the communication path information 214. The confirmation unit 271 is further configured to determine that the mobile node 19 is moving toward the second signal coverage according to the calculation result 276, so as to add the access point B to the transmission list 270.

In particular, assuming that the wireless network 1 needs to broadcast via four access points and the communication path relating to the access point B has a depth of one access point, then the broadcast overhead information 212 is equal to 4 and the communication path information 214 is equal to 1. Furthermore, according to Table 2 and the aforesaid assumption that the previous position of the mobile node 19 is at the access point A, the current position is also at the access point A and the next position will be the access point B, the updated probability information 216 is 70.3%. As the broadcast overhead information 212 divided by the communication path information 214 is greater than the updated probability information 216, the confirmation unit 271 determines that the access point B shall be added to the transmission list 270 according to the calculation result 276.

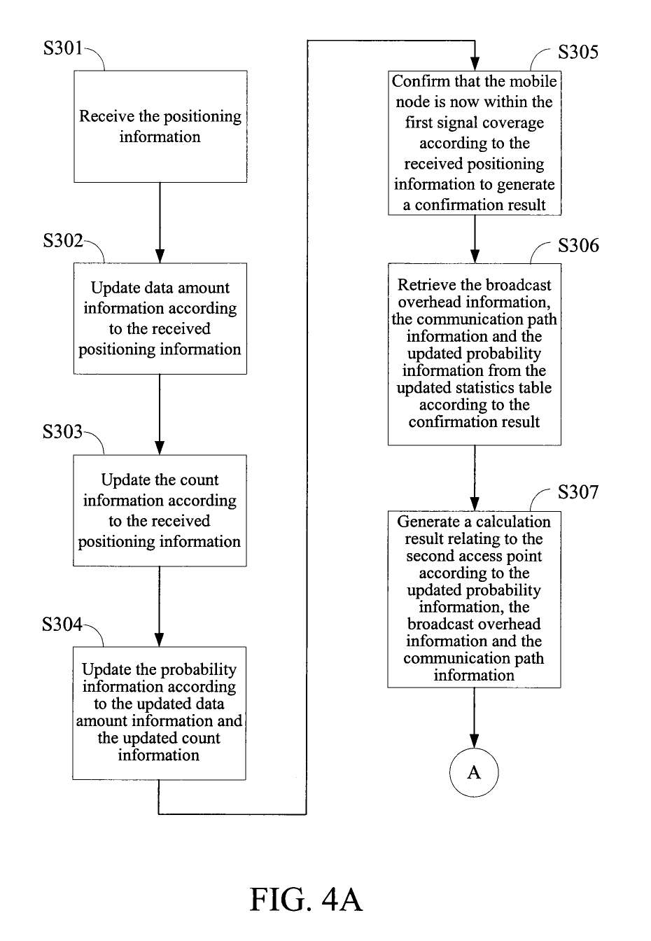

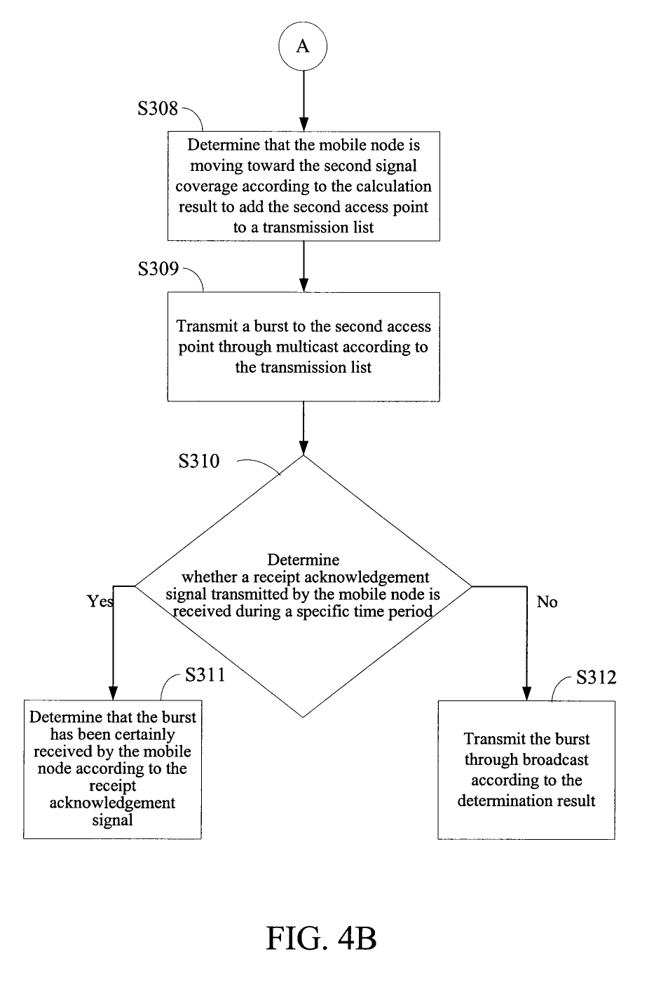

FIGS. 4A and 4B depict a second embodiment of the present invention, which is a transmission method adapted for a host apparatus, e.g., the host apparatus 2 described in the first embodiment. The host apparatus 2 is adapted for use in a wireless network comprising a first access point, a second access point and a mobile node. The host apparatus is wirelessly connected to the first access point and the second access point and stores a statistics table relating to the mobile node. The statistics table contains data amount information, count information corresponding to the mobile node, probability information, broadcast overhead information, and communication path information corresponding to the second access point. The first access point has a first signal coverage and transmits positioning information relating to the mobile node to the host apparatus, the second access point has a second signal coverage, and the mobile node is within the first signal coverage.

In particular, the transmission method of the second embodiment may be implemented by a computer program product, when being loaded into the host apparatus 2 via a computer and a plurality of codes thereof are executed, can accomplish the transmission method of the second embodiment. This computer program product may be stored in a tangible machine-readable medium, such as a read only memory (ROM), a flash memory, a floppy disk, a hard disk, a compact disk, a mobile disk, a magnetic tape, a database accessible to networks, or any other storage media with the same function and well known to those skilled in the art.

Referring first to FIG. 4A, step S301 is first executed to receive the positioning information. Then step S302 is executed to update data amount information according to the received positioning information, step S303 is executed to update the count information according to the received positioning information, and step S304 is executed to update the probability information according to the updated data amount information and the updated count information. Briefly speaking, steps S302 through S304 may be viewed as a single step of updating the statistics table according to the received positioning information.

Next, step S305 is executed to confirm that the mobile node is now within the first signal coverage according to the received positioning information to generate a confirmation result. Step S306 is executed to retrieve the broadcast overhead information, the communication path information and the updated probability information from the updated statistics table according to the confirmation result. Subsequently, step S307 is executed to generate a calculation result relating to the second access point according to the updated probability information, the broadcast overhead information and the communication path information.

Referring to FIG. 4B, step S308 is executed to determine that the mobile node is moving toward the second signal coverage according to the calculation result to add the second access point to a transmission list. Then step S309 is executed to transmit a burst to the second access point through multicast according to the transmission list so that the mobile mode may receive the burst via the second access point after entering the second signal coverage. Afterwards, step S310 is executed to determine whether a receipt acknowledgement signal transmitted by the mobile node is received during a specific time period after transmitting the burst, so as to generate a determination result.

If the determination result indicates that the acknowledgement receiving result is received during the specific time period, then step S311 is executed to determine that the burst has been certainly received by the mobile node according to the receipt acknowledgement signal. Otherwise, if the determination result indicates that the acknowledgement receiving result is not received during the specific time period, then step S312 is executed to transmit the burst through broadcast according to the determination result so that the mobile node may receive the burst via one of the first access point and the second access point.

In addition to the aforesaid steps, the second embodiment can also execute all the operations and functions set forth in the first embodiment. How the second embodiment executes these operations and functions will be readily appreciated by those of ordinary skill in the art based on the explanation of the first embodiment, and thus will not be further described herein.

In summary, the present invention provides a solution for wireless communication. According to this solution, access points in possible moving paths of a mobile node are known from a statistics table, and then signal transmissions (i.e., burst transmissions) to the mobile node are carried out through multicast via the access points in the possible moving paths. This solution may not only provide mobile nodes in the wireless network with good wireless communication quality, but also reduce unnecessary consumption of wireless network resources and usage of register space resources of access points.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A host apparatus for use in a wireless network comprising a first access point, a second access point and a mobile node, the host apparatus being wirelessly connected to the first access point and the second access point, the first access point having a first signal coverage and transmitting positioning information relating to the mobile node to the host apparatus, the second access point having a second signal coverage, the mobile node being within the first signal coverage, the host apparatus comprising:
a storage module, being configured to store a statistics table relating to the mobile node;
a transceiver, being configured to receive the positioning information;
an update module, being configured to update the statistics table of the storage module according to the received positioning information; and
a determination module, being configured to confirm the mobile node being currently within the first signal coverage according to the received positioning information to generate a confirmation result, and determine the mobile node is moving toward the second signal coverage according to the updated statistics table and the confirmation result, so as to add the second access point to a transmission list;
wherein the transceiver is further configured to transmit a burst to the second access point in a multicast way according to the transmission list so that the mobile node may receive the burst via the second access point after entering the second signal coverage.

2. The host apparatus of claim 1, wherein the determination module is further configured to determine whether the transceiver receives a receipt acknowledgement signal transmitted by the mobile node during a specific time period after transmitting the burst, so as to generate a determination result.

3. The host apparatus of claim 2, wherein if the determination result indicates that the transceiver receives the receipt acknowledgement signal during the specific time period, the determination module is further configured to determine the burst is certainly received by the mobile node according to the receipt acknowledgement signal.

4. The host apparatus of claim 2, wherein if the determination result indicates that the transceiver doesn't receive the receipt acknowledgement signal during the specific time period, the determination module is further configured to generate an enable signal according to the determination result, the transceiver is further configured to transmit the burst in a broadcast way according to the enable signal so that the mobile node may receive the burst via one of the first access point and the second access point.

5. The host apparatus of claim 1, wherein the statistics table comprises data amount information, count information and probability information, the count information and the probability information correspond to the mobile node, the update module is further configured to respectively update the data amount information and the count information according to the received positioning signal, the update module is further configured to update the probability information according to the updated data amount information and the updated count information, so as to generate the updated statistics table.

6. The host apparatus of claim 5, wherein the statistics table further comprises broadcast overhead information, and communication path information corresponding to the second access point, the determination module comprises:
a confirmation unit, being configured to confirm the mobile node is within the first signal coverage according to the received positioning information to generate the confirmation result;
a retrieving unit, being configured to retrieve the broadcast overhead information, the communication path information and the updated probability information from the updated statistics table according to the confirmation result; and
a calculation unit, being configured to generate a calculation result, relating to the second access point, according to the updated probability information, the broadcast overhead information and the communication path information;
wherein the confirmation unit is further configured to determine the mobile node is moving toward the second signal coverage according to the calculation result, so as to add the second access point to the transmission list.

7. A transmission method for use in a host apparatus, the host apparatus being adapted to be used in a wireless network, the wireless network comprising a first access point, a second access point and a mobile node, the host apparatus being wirelessly connected to the first access point and the second access point, and storing a statistics table relating to the mobile node, the first access point having a first signal coverage and transmitting positioning information relating to the mobile node to the host apparatus, the second access point having a second signal coverage, the mobile node being within the first signal coverage, the transmission method comprising the following steps of:
(a) receiving the positioning information;
(b) updating the statistics table according to the received positioning information;
(c) confirming the mobile node is within the first signal coverage according to the received positioning information to generate a confirmation result;
(d) determining the mobile node is moving toward the second signal coverage according to the updated statistics table and the confirmation result to add the second access point to a transmission list; and
(e) transmitting a burst to the second access point in a multicast way according to the transmission list so that the mobile mode may receive the burst via the second access point after entering the second signal coverage.

8. The transmission method of claim 7, further comprising the following step of:
determining whether a receipt acknowledgement signal transmitted by the mobile node is received during a specific time period after transmitting the burst, so as to generate a determination result.

9. The transmission method of claim 8, wherein if the determination result indicates the receipt acknowledgement signal is received during the specific time period, the transmission method further comprises the following step of:
determining the burst is certainly received by the mobile node according to the receipt acknowledgement signal.

10. The transmission method of claim 8, wherein if the determination result indicates the receipt acknowledgement signal is not received during the specific time period, the transmission method further comprises the following step of:
transmitting the burst in a broadcast way according to the determination result so that the mobile node may receive the burst via one of the first access point and the second access point.

11. The transmission method of claim 7, wherein the statistic table comprises data amount information, count information and probability information, the count information and the probability information correspond to the mobile node, the step (b) comprises the following steps of:
updating the data amount information according to the received positioning information;
updating the count information according to the received positioning information; and
updating the probability information according to the updated data amount information and the updated count information.

12. The transmission method of claim 11, wherein the statistic table further comprises broadcast overhead information, and communication path information corresponding to the second access point, the step (d) comprises the following steps of:
confirming the mobile node is within the first signal coverage according to the positioning information to generate the confirmation result;
retrieving the broadcast overhead information, the communication path information and the updated probability information from the updates statistic table according to the confirmation result;
generating a calculation result, relating to the second access point, according to the updated probability information, the broadcast overhead information and the communication path information; and determining the mobile node is moving toward the second signal coverage according to the calculation result, so as to add the second access point to the transmission list.

13. A tangible machine-readable medium storing a program of a transmission method for use in a host apparatus, the host apparatus being adapted to be used in a wireless network and comprising a storage module, a transceiver, an update module and a determination module, the wireless network comprising a first access point, a second access point and a mobile node, the host apparatus being wirelessly connected to the first access point and the second access point, the storage module storing a statistic table relating to the mobile node, the first access point having a first signal coverage and transmitting positioning information relating to the mobile node to the host apparatus, the second access point having a second signal coverage, the mobile node being within the first signal coverage, the program comprising:
a code A enabling the transceiver to receive the positioning information;
a code B enabling the update module to update the statistic table according to the received positioning information;
a code C enabling the determination module to confirm the mobile node is currently within the first signal coverage according to the received positioning information to generate a confirmation result;
a code D enabling the determination module to determine the mobile node is moving toward the second signal coverage according to the updated statistic table and the confirmation result to add the second access point to the transmission list; and
a code E enabling the transceiver to transmit a burst to the second access point in a broadcast way according to the transmission list so that the mobile node may receive the burst via the second access point after entering the second signal coverage.

14. The tangible machine-readable medium of claim 13, wherein the program further comprises:
a code F enabling the determination module to determine whether the transceiver receives a receipt acknowledgement signal transmitted by the mobile node during a specific time period after transmitting the burst to generate a determination result.

15. The tangible machine-readable medium of claim 14, wherein if the determination result indicates that the transceiver receives the receipt acknowledgement signal during the specific time period, the program further comprises:
a code G enabling the determination module to determine the burst is certainly received by the mobile node according to the receipt acknowledgement signal.

16. The tangible machine-readable medium of claim 14, wherein if the determination result indicates that the transceiver does not receive the receipt acknowledgement signal during the specific time period, the program further comprises:
a code H enabling the determination module to generate an enable signal according to the determination result; and
a code I enabling the transceiver to further transmit the burst in a broadcast way according to the enable signal so that the mobile node may receive the burst via one of the first access point and the second access point.

17. The tangible machine-readable medium of claim 13, wherein the determination module comprises a confirmation unit, the code C is to enable the confirmation unit of determination module to confirm the mobile node is within the first signal coverage according to the received positioning information, so as to generate the confirmation result.

18. The tangible machine-readable medium of claim 13, wherein the statistic table comprises data amount information, count information and probability information, the count information and the probability information corresponds to the mobile node, the code B further comprises:
a code B1 enabling the update module to update the data amount information according to the received positioning information;
a code B2 enabling the update module to update the count information according to the received positioning information; and
a code B3 enabling the update module to update the probability information according to the updated data amount information and the updated count information.

19. The tangible machine-readable medium of claim 18, wherein the determination module comprises a retrieving unit, a calculation unit and a confirmation unit, the statistic table further comprises broadcast overhead information and communication path information corresponding to the second access point, the code D further comprises:
a code D1 enabling the retrieving unit to retrieve the broadcast overhead information, the communication path information and the updated probability information from the updated statistic table according to the confirmation result,
a code D2 enabling the calculation unit to generate a calculation result relating to the second access point according to the updated probability information, the broadcast overhead information and the communication path information; and
a code D3 enabling the confirmation unit to determine the mobile node is moving toward the second signal coverage according to the calculation result, so as to add the second access point to the transmission list.
